(19) United States
(12) Patent Application Publication
(10) Pub. No.: US 2010/0187832 A1
(43) Pub. Date: Jul. 29, 2010

(54) DEVICES FOR RECEIVING AND USING ENERGY FROM A BUILDING ENVIRONMENT

(75) Inventors: Scott T. Holland, Brookfield, WI (US); Thomas J. Menden, New Berlin, WI (US); Matthew J. Asmus, Watertown, WI (US); Kirk H. Drees, Cedarburg, WI (US); John I. Ruiz, New Berlin, WI (US); Timothy J. Gamroth, Dousman, WI (US); Thomas M. Seneczko, Hartland, WI (US); Philip L Bushong, Franklin, WI (US); Paul D. Brunette, Milwaukee, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/670,832

(22) PCT Filed: Jul. 28, 2008
(86) PCT No.: PCT/US08/71354

§ 371 Date: Jan. 26, 2010

Related U.S. Application Data
(60) Provisional application No. 60/962,697, filed on Jul. 31, 2007.
(60) Provisional application No. 61/039,013, filed on Mar. 24, 2008.

(51) Int. Cl. H02N 2/18; G06F 19/00; H02J 7/34; G01D 5/14; G01D 21/02

(52) U.S. Cl. 290/1 A; 702/127; 307/66; 324/71.1; 310/339

(57) ABSTRACT

A device for use in a building automation system includes a first circuit configured to receive non-electrical energy from an environment in which the device is placed and convert the non-electrical energy to electrical energy. The electrical energy is used to power the first circuit. The first circuit configured to sense a parameter based on the non-electrical energy. A communications interface configured to be powered by the electrical energy and configured to communicate the sensed parameter to the building automation system.

### CROSS-REFERENCE TO RELATED PATENT APPLICATIONS

This application claims the benefit of U.S. Provisional Application 60/962,697, filed Jul. 31, 2007, which is incorporated herein by reference in its entirety. This application also claims the benefit of U.S. Provisional Application 61/039,013, filed Mar. 24, 2008, which is incorporated herein by reference in its entirety.

### BACKGROUND

The present disclosure relates generally to the field of building automation systems. More specifically, the present disclosure relates to the field of energy conversion or energy harvesting by wireless building automation system devices.

Building automation system devices (e.g., sensors, actuators, routers, etc.) typically require power supplied from a battery or a wired source of power to function properly. The present disclosure presents building automation system devices for receiving and using energy from a building environment.

### SUMMARY

One embodiment relates to a device for use in a building automation system. The device includes a first circuit configured to receive non-electrical energy from an environment in which the device is placed and convert the non-electrical energy to electrical energy. The electrical energy is used to power the first circuit. The first circuit configured to sense a parameter based on the non-electrical energy. A communications interface configured to be powered by the electrical energy and configured to communicate the sensed parameter to the building automation system.

Another embodiment relates to a method for converting energy in a building automation system. The method includes receiving non-electrical energy at a first circuit from an environment in which the first circuit is placed, converting the non-electrical energy to electrical energy using the first circuit, powering the first circuit and a communications interface using the electrical energy, sensing a parameter based on the non-electrical energy using the first circuit, and communicating the sensed parameter to the building automation system using the communications interface.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is a perspective view of a building, according to an exemplary embodiment;

FIG. 2A is a schematic diagram of a building automation system, according to an exemplary embodiment;

FIG. 2B is a schematic diagram of a building automation system wherein many of the field-level building automation system devices are wireless, according to another exemplary embodiment;

FIG. 3A is a block diagram of a controller and a wireless device, the wireless device including a circuit for receiving and converting energy, according to an exemplary embodiment;

FIG. 3B is a block diagram of the wireless device shown in FIG. 3A, according to an exemplary embodiment;

FIG. 3C is a block diagram of a wireless device coupled having a portion of the circuit for receiving and converting energy located within the device and another portion of the circuit located on and/or external to the device, according to another exemplary embodiment;

FIG. 3D is a block diagram of a wireless device coupled to a circuit located external the wireless device (e.g., retrofit to the wireless device) for receiving and converting energy, according to another exemplary embodiment;

FIG. 4A is a block diagram of power supply circuitry for the wireless device of FIGS. 3A-D, according to various exemplary embodiments;

FIG. 4B is a block diagram of a wireless device and power supply circuitry, according to another exemplary embodiment;

FIG. 4C is a block diagram of the wireless device and power supply circuitry shown in FIG. 4B, but with the power supply circuitry shown as detachably coupled (e.g., via a retrofit configuration) to the wireless device;

FIG. 4D is a detailed block diagram of a configuration for providing a power supply for the wireless device of FIGS. 3A-D, according to an exemplary embodiment;

FIG. 5 is a diagram of a mesh network that may be formed by a plurality of wireless devices, according to an exemplary embodiment;

FIG. 6 is a perspective view of a building area with a plurality of wireless devices that include circuits for receiving and converting energy, according to an exemplary embodiment;

FIG. 7A is a schematic perspective view of a piezoelectric sensor in an air duct, according to an exemplary embodiment;

FIG. 7B is a schematic perspective view of a piezoelectric sensor mounted on the outside of an air duct, according to an exemplary embodiment;

FIG. 7C is a schematic diagram of a piezoelectric sensor and air flow in an air duct, according to an exemplary embodiment;

FIG. 8A is an environment view of a photovoltaic sensor for providing electrical energy to a wireless device, according to an exemplary embodiment;

FIG. 8B is a block diagram of circuitry for providing electrical energy from solar cells to a wireless device, according to an exemplary embodiment;

FIG. 9A is a schematic view of an air duct and thermoelectric generator, according to an exemplary embodiment;

FIG. 9B is a schematic view of an air duct and thermoelectric generator, according to another exemplary embodiment;

FIG. 10 is a schematic view of a brushless motor, according to an exemplary embodiment; and

FIG. 11 is a flow chart illustrating a method for converting energy in a building automation system according to an exemplary embodiment.

### DETAILED DESCRIPTION

Before turning to the figures which illustrate the various embodiments of the disclosure in detail, it should be understood that the application is not limited to the details or methodology set forth in the following description or illustrated in the figures. It should also be understood that the terminology employed herein is for the purpose of description only and should not be regarded as limiting.

Referring to various exemplary embodiments shown in the Figures and described with reference thereto, devices for use in a building automation system are shown and described. The devices can be building automation system devices. The devices are generally shown to include circuitry (i.e., “energy harvesting” or “energy conversion” circuitry) configured to receive non-electrical energy from an environment (e.g. a building zone, a building room, etc.) in which the device is placed and to convert the non-electrical energy to electrical energy. The same circuitry is also used to sense a parameter of the environment and/or to serve some other building automation system function (e.g., routing building automation system network information, etc.). Further, the electrical energy provided by the circuitry is used to power the circuitry and a communications interface. The communications interface, according to an exemplary embodiment, is a wireless radio frequency communications interface configured to communicate the sensed parameter to the building automation system and/or to communicate other building automation system information.

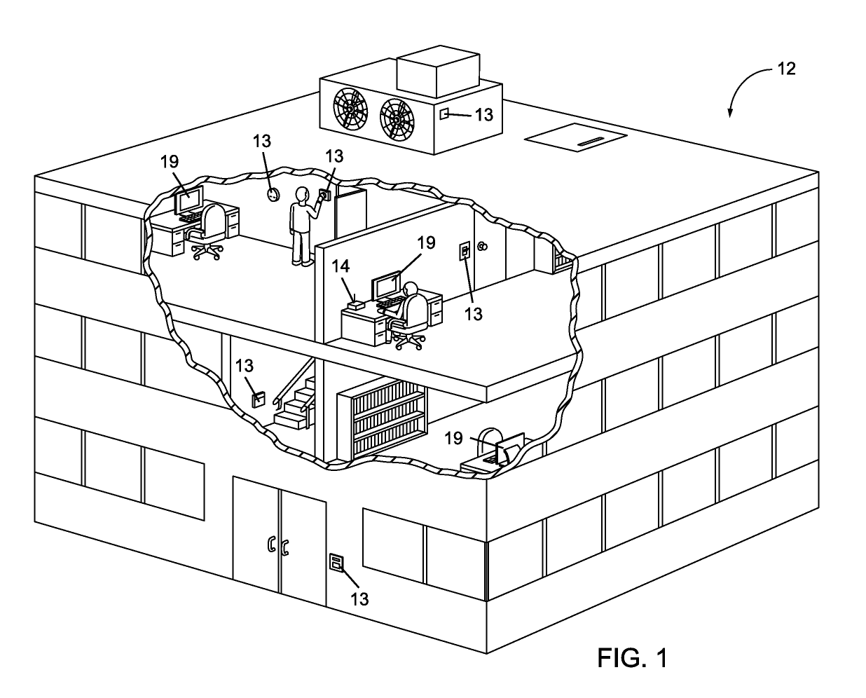

FIG. 1 is a perspective view of a building 12 having a plurality of devices 13 (e.g., wireless radio frequency (“RF”) devices) capable of transmitting and/or receiving signals, according to an exemplary embodiment. Building 12 may include any number of floors, rooms, and/or other building structures. According to various exemplary embodiments, building 12 may be of any size or type, and may include an outdoor area. Devices 13 may exist inside or outside the building, on walls or on desks, be user interactive or not, and may be any type of device. For example, devices 13 may be security devices, light switches, fan actuators, temperature sensors, thermostats, smoke detectors, occupancy sensors, or any other type of sensor (e.g., CO2, flow, pressure). A control system 14 is shown as a desktop wireless device. A workstation 19 is shown as a personal workstation. Control system 14 may serve as a network coordinator, wireless access point, router, switch, hub, and/or serve as another node on a network. Workstation 19 may allow building engineers to interact with the control system. Devices 13, controller 14, and workstation 19 may be part of a building automation system.

A building automation system (“BAS”) may be a hardware and/or software system configured to control, monitor, and manage equipment in or around a building or building area. BAS equipment can include a heating, ventilation, and air conditioning (“HVAC”) system, a security system, a lighting system, a fire alerting system, an elevator system, a system that is capable of managing building functions, or any combination thereof. The devices described herein for receiving, sensing, and/or converting energy can be devices of a building automation system; however, other building automation systems may be used in its place. According to other exemplary embodiments, circuits for receiving, sensing and converting energy may be used in conjunction with any type of system (e.g., a general purpose office local area network (“LAN”), home HVAC components, a home LAN, a wide area network (“WAN”), a wireless hotspot, etc.).

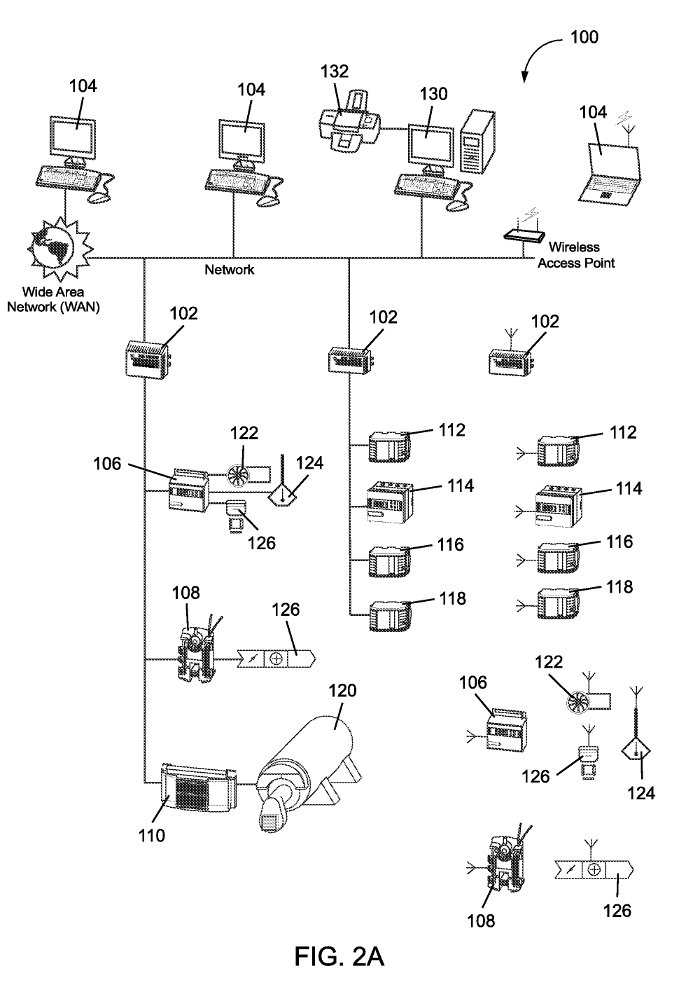

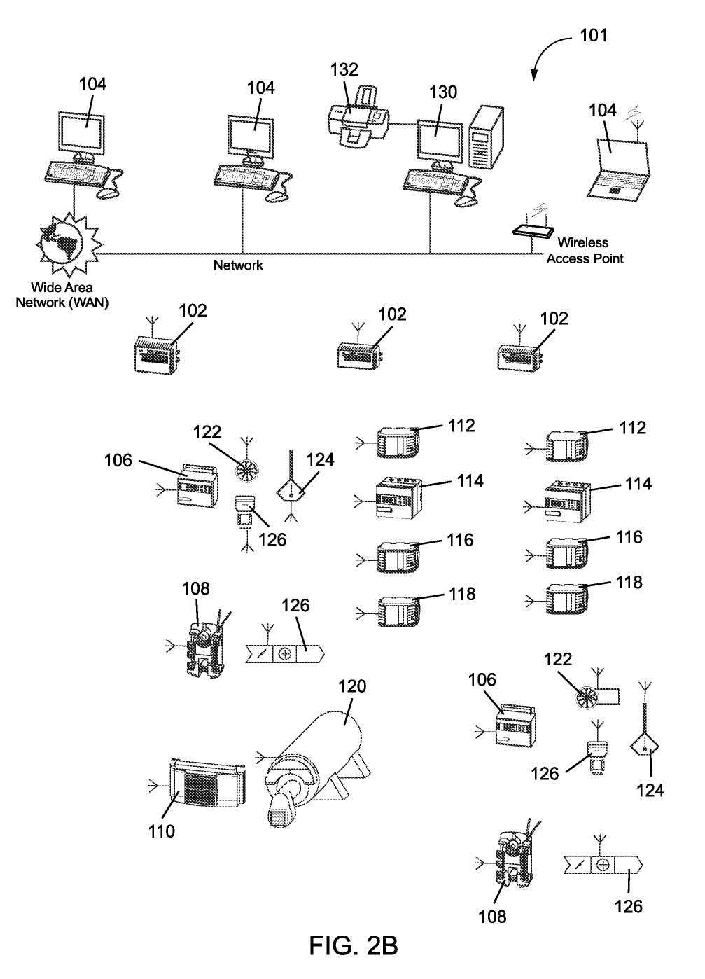

Referring to FIG. 2A, a schematic diagram of a BAS 100 is shown that may be used with the devices and methods of the present disclosure, according to an exemplary embodiment. BAS 100 may include one or more supervisory controllers 102 (e.g., a network automation engine (“NAE”)) connected to a proprietary or standard communications network such as an IP network (e.g., Ethernet, Wi-Fi, etc). Supervisory controllers 102 may support various field-level communications protocols and/or technology, including various Internet Protocols (“IP”), BACnet over IP, BACnet Master-Slave/Token-Passing (“MS/TP”), N2 Bus, N2 over Ethernet, Wireless N2, LonWorks, ZigBee, and any number of other standard or proprietary field-level building management protocols and/or technologies. Supervisory controllers 102 may include varying levels of supervisory features and building management features. User interfaces for supervisory controllers 102 may be accessed via terminals 104 (e.g., web-browser terminals) capable of communicably connecting to and accessing supervisory controllers 102. For example, FIG. 2A shows multiple terminals that may be variously connected to supervisory controllers 102 or other devices of BAS 100. For example, terminals 104 may access BAS 100 and connected supervisory controllers 102 via a WAN, local IP network, or a connected wireless access point.

Supervisory controllers 102 may be connected to any number of BAS devices. The devices may include, among other devices, devices such as field equipment controllers (“FECs”) 106 and 110 such as field-level control modules, variable air volume modular assemblies (“VMAs”) 108, integrator units, room controllers 112 (e.g., a variable air volume (“VAV”) device or unit), other controllers 114, unitary devices 116, zone controllers 118 (e.g., an air handling unit (“AHU”) controller), boilers 120, fan coil units 122, heat pump units 124, unit ventilators or VAV devices 126, expansion modules, blowers, temperature sensors, flow transducers, other sensors, motion detectors, actuators, dampers, heaters, air conditioning units, etc. These devices may generally be controlled and/or monitored by supervisory controllers 102. Data generated by or available on the various devices that are directly or indirectly connected to supervisory controller 102 may be passed, sent, requested, or read by supervisory controller 102 and/or sent to various other systems or terminals 104 of BAS 100.

Referring still to FIG. 2, an enterprise server 130 (e.g., an application and data server (ADS)) is shown, according to an exemplary embodiment. Enterprise server 130 is a server system that includes a database management system (e.g., a relational database management system, Microsoft SQL Server, SQL Server Express, etc.) and server software (e.g., web server software, application server software, virtual machine runtime environments, etc.) that can provide access to data and route commands to BAS 100. For example, enterprise server 130 may serve user interface applications. Enterprise server 130 may also serve applications such as Java applications, messaging applications, trending applications, database applications, etc. Enterprise server 130 may store trend data, audit trail messages, alarm messages, event messages, contact information, and/or any number of BAS-related data. Terminals may connect to enterprise server 130 to access the entire BAS 100 and historical data, trend data, alarm data, operator transactions, and any other data associated with BAS 100, its components, or applications. Various local devices such as printer 132 may be attached to components of BAS 100 such as enterprise server 130.

Devices are shown as either wired devices or wireless devices. Some devices are shown as having a wired connection with a supervisory controller 102, while other devices may be wirelessly connected to a supervisory controller 102. Devices with wireless connections may have an antenna system used to communicate wirelessly with a supervisory controller 102. The antenna systems may transmit data to a supervisory controller 102, another wireless device, or a wired device. Likewise, a device with a wired connection may transmit data to a supervisory controller 102, another wired device, or a wireless device. The wired connections as shown in FIG. 2A may include a wired connection to a power source. The wireless devices of FIG. 2A may provide their own power source or may be provided with a power source within BAS 100.

Referring to FIG. 2B, a schematic diagram of a BAS 101 is shown that may be used with the systems and methods disclosed in the present application, according to another exemplary embodiment. FIG. 2B shows many wireless devices (e.g., devices 106-126), including supervisory controllers 102. Each wireless device may wirelessly transmit data to and/or receive data from other devices and supervisory controllers 102.

The location of each device and supervisory controller of the building system may vary, according to exemplary embodiments. For example, some devices and sensors may be placed in the floor to detect occupancy. Other devices may be placed in the ceiling (e.g., in air ducts) to detect air flow and other air properties of the building area. Yet other devices and sensors may be placed within walls, outside of walls in plain view of a user of the building area, or in any other area. As shown in FIGS. 2A and 2B, devices of the BAS may be wireless such that they do not require the use of a wired connection, either for power or communications, according to an exemplary embodiment. Further, some devices may be portable such that the position of any device within the building area may be easily changed without significant cost or effort, according to an exemplary embodiment.

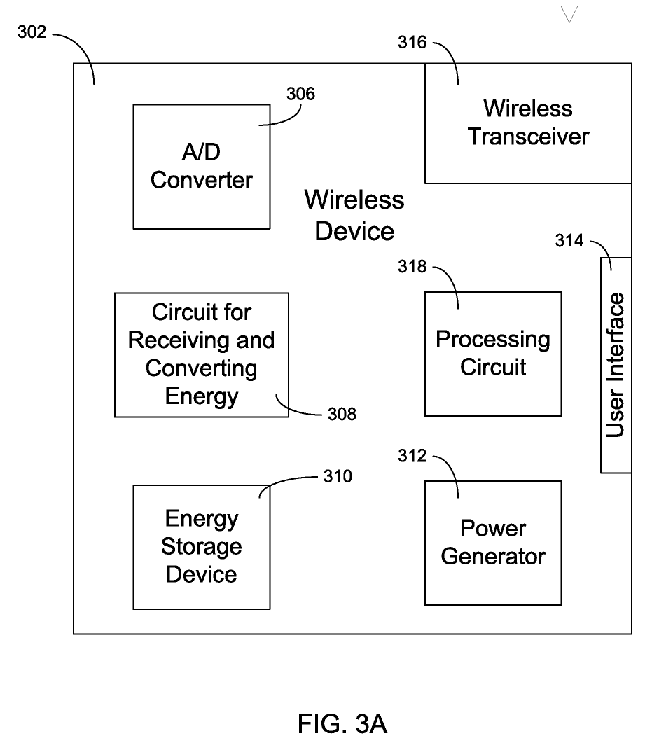

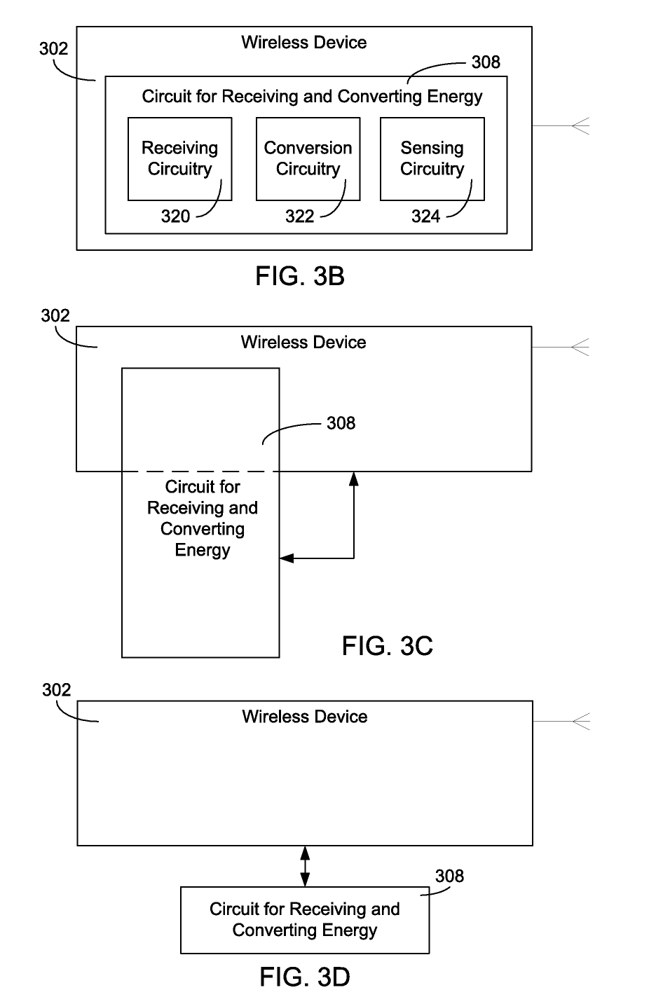

Referring to FIG. 3A, a block diagram of a wireless device 302 is shown, according to an exemplary embodiment. Wireless device 302 may be used in BAS 101 of FIG. 2B or another building system.

A circuit 308 for receiving and converting energy receives non-electrical energy (e.g., mechanical energy, thermal energy, light energy, etc.) and converts the non-electrical energy into electrical energy. The electrical energy may be used to power circuit 308 for receiving and converting energy, wireless transceiver 316, other circuitry of wireless device 302, and/or wireless device 302 in its entirety. According to an exemplary embodiment, circuit 308 also measures, senses, and/or calculates a parameter based on the non-electrical energy (e.g., an air flow rate, a temperature, etc.). Wireless transceiver 316 may use the electrical energy to send the sensed parameter to BAS 100. Circuit 308 may be coupled to an analog-to-digital (“A/D”) converter 306, another converter, or a processing circuit 318 to assist in interpreting data (e.g., for transmission via a digital data communications network). Wireless device 302 may also include an energy management system used to configure and control use of the converted electrical energy for wireless device 302.

Processing circuit 318 may be configured to control one or more of the components within or coupled to wireless device 302. For example, processing circuit 318 may be configured to coordinate communications between components (e.g., circuit 308 to A/D converter 306 to wireless transceiver 316). Processing circuit 318 may include or be coupled to a memory for storing temporary data (e.g., information sensed by circuit 308), storing computer code for conducting the activities described herein, or for conducting any other activity. The memory device can be used, for example, to store instructions or algorithms that the processing circuit can execute and/or for reading and writing data available at processing circuit 318 and/or circuit 308 and/or transceiver 316. According to various exemplary embodiments, processing circuit 318 may be any processing circuit that is capable of controlling one or more of the components within or coupled to wireless device 302.

Wireless device 302 is shown to includes a wireless transceiver or radio 316. Transceiver 316 (e.g., a communications interface) includes an antenna system used for transmitting signals to and/or from other devices, controllers, and NAE of the building system. Transceiver 316 may be a ZigBee transceiver, a radio frequency identification (“RFID”) transceiver, a Wi-Fi transceiver, a Bluetooth transceiver, a near field communications transceiver, an infrared transceiver, a WiMAX transceiver, an RF transceiver suitable for data communications, or any other wireless communications interface.

Wireless device 302 is also shown to include power generator 312 which may be configured to provide a power supply for wireless device 302, according to an exemplary embodiment. In addition, power generator 312 may include an interface to couple to a wired power source if desired by a user of the device. An energy storage device 310, such as a battery or capacitor, may also be coupled to or a part of power generator 312 and configured to store and/or supply power to wireless device 302. Energy storage device 310 may include a battery that can be changed when the battery no longer has a charge to provide a power supply. According to various other exemplary embodiments, wireless device 302 may not include energy storage device 310.

Circuit 308 and power generator 312 may be coupled or otherwise in communication with one another. For example, power generator 312 may receive an electrical input in a first form (e.g., alternating current form) from circuit 308 and convert the input into a second form (e.g., direct current) for supplying power back to circuit 308, to wireless transceiver 316, etc. According to another exemplary embodiment, circuit 308 and power generator 312 may be combined into a single component of wireless device 302.

Referring now to FIG. 3B, circuit 308 is shown to include receiving circuitry 320, conversion circuitry 322, and sensing circuitry 324. Receiving circuitry 320 is configured to receive the non-electrical energy. Conversion circuitry 322 is configured to convert the non-electrical energy into electrical energy that may be used to power wireless device 302 or any of the components therein. Sensing circuitry 324 is configured to sense or calculate a parameter or property based on the received non-electrical energy or the converted electrical energy.

According to some exemplary embodiments, the tasks of receiving, sensing, and converting the non-electrical energy is all handled by circuit 308. For example, the voltage produced by an energy conversion technique may be correlated to a rate of air flow by sensing circuitry 324, thereby providing a measure of the rate of air flow. As another example, voltage produced by a flow (e.g., a water flow, air flow, etc.) received by receiving circuitry 320 may be used by sensing circuitry 324 to calculate a rate of flow. In other words, the same energy (e.g., mechanical energy) received for sensing purposes may be used for the generation of electrical energy.

Referring to FIG. 3C, according to other exemplary embodiments, at least a portion of the circuit 308 for receiving and converting energy (e.g., receiving circuitry 320, sensing circuitry 324, and conversion circuitry 322) may be located outside of or external to wireless device 302 and coupled to wireless device 302. Alternatively, as shown in FIG. 3D, the entirety of circuit 308 may be external to and coupled to wireless device 302. The configurations of FIGS. 3C and 3D may be used when retrofitting circuit 308 to an existing wireless device. For example, an existing wireless temperature sensing device may be fit with a new temperature sensing element (e.g., circuitry) and may also be fit with new circuitry for converting energy received by the temperature sensing element and new sensing circuitry. The power converted by the new circuitry may be fed into existing wireless communications components and/or power supply components. The wireless device of FIGS. 3C and 3D may include the components and devices shown and described in FIG. 3A and/or FIG. 3B.

It should be noted that although some embodiments shown in the disclosure may relate to a specific configuration of wireless devices, conversion circuitry, receiving circuitry, and/or sensing circuitry, many configurations are possible for various applications, and all such configurations are within the scope of the disclosure.

The wireless device and its components may be configured to convert a first type of energy or input (e.g., temperature difference for a thermoelectric or pyroelectric sensor, air flow for a brushless motor, eddy currents or other sources of vibrational energy for a piezoelectric sensor, frictional energy for an electrostatic sensor, etc.) from conversion circuitry 322 into a supply of electrical energy that can be used to sufficiently power the wireless device and sensor without the use of an outside power source. Conversion circuitry 322 may further include the capability to provide a supply of electrical energy to an energy storage device. In such an embodiment, the instantaneous supply of electrical energy might not be sufficient to power the wireless device, but electrical energy provided to an energy storage device when the sensor is not in use can result in sufficient charge at the energy storage device so that the wireless device can be used as intended without requiring the use of a wired (e.g., mains) power source. In other words, the wireless device may depend upon the conversion circuitry to provide the sole power source for the wireless device, according to an exemplary embodiment.

Transceiver 316 of wireless device 302 may be configured to require relatively low power to function properly, assisting the conversion circuitry in that the power level required to be generated by the retrieving circuitry and/or conversion circuitry may be lowered. Various properties or parameters of the activities of the wireless device may be altered to improve the performance of the wireless device depending on power usage and/or availability. For example, the frequency and/or size of the messages to be transmitted by transceiver 316 may be altered. A message that may usually be transmitted once per second may instead be transmitted once every three or four seconds if there is insufficient power available or insufficient energy conversion underway.

Conventional sensing and transmission circuitry senses and transmits data at a fixed period, often much faster than required. According to an exemplary embodiment, the circuitry of wireless device 302 (e.g., circuitry 308, processing circuit 318, transceiver circuitry 316, etc.) may be configured to have a sample period that is some fraction of the time constant of the process being controlled or the parameter being sensed. For example, the sensor may take a measurement and/or transmit the measurement with a ⅙th time constant of the process being controlled or the parameter being sensed. If the time constant is unknown, the time constant may be set to “worst case” rate that is at or faster than what may be the minimum period. If the circuitry has knowledge of the time constant, it may adjust the sample period to a fraction of the process time constant, transmit as needed, use less energy, and increase battery or power source life or the converted power available.

If the sample time is based on the time constant, the amount of energy needed for conversion can be reduced. Circuitry 308 can obtain the process time constant and adjust the sample rate according to the time constant. In the ⅙th time constant embodiment, the sensing circuitry may be configured to take a measurement and/or to make a calculation every 60 seconds, assuming a process time constant of 360 seconds. According to such an embodiment, over the course of a day the circuitry will sense and transmit 1440 times. If the zone has a time constant of 1080 seconds and if the circuitry adjust the period according to the time constant, the circuitry may only sense and transmit 480 times.

The wireless device may also (or alternatively) be configured to provide event driven messages instead of periodic messages in order to save power. For example, for a light sensor, a message may only be transmitted when the lights are turned off or on, instead of providing a message periodically. The amplitude of the message may vary based on the power usage and/or availability as well. The transmission power may increased when more power is available and reduced when less power is available.

The wireless device may also adjust message size based on the available power. For example, processing circuit 318 may decide to transmit a shorter message during reduced power situations and a longer message during full power situations. For example, in reduced power situations the wireless device may transmit messages without appending identifier information. According to other exemplary embodiments, the wireless device may decide to transmit without encrypting or otherwise processing the information to be transmitted. A controller receiving the message may be able to identify the source of the message without being provided with identification data. For example, a controller may be configured to recognize the wireless device a message was transmitted from based on the characteristics of the message (e.g., signal strength). According to yet other exemplary embodiments, the controller and the wireless device may establish a truncated identification (e.g., a controller having four wireless devices connected thereto may assign identification numbers 1-4 to the wireless devices). Further, in a mesh network or any other network, the devices may be configured such that each wireless device may have a designated controller to transmit to, allowing the use of a wireless device identifier to be expendable. A wireless device may also transmit a shorter message by omitting other select information. For example, instead of transmitting a message that effectively communicates “the current temperature is 40 degrees Celsius,” a transmitted message may simply be “40,” and the controller may be configured to interpret the received message as being a temperature in the format of degrees Celsius.

Circuit 308 and wireless device 302 may have various power modes allowing for the conservation of electrical energy or power. For example, wireless device 302 may enter an “idle” mode where little power consumption occurs and the circuitry stores power in energy storage device 310. There may also be a “sense” mode when circuit 308 and/or wireless device 302 is measuring a parameter or property based on the non-electrical or electrical energy (e.g., an air flow, a temperature, an amount of light, etc.). There may also be a “transmit” mode where wireless device 302 sends data (e.g., data collected during the “sense” mode). Wireless device 302 may be configured to use the “transmit” mode sparingly because it requires the highest power consumption. Wireless device 302 may also have a “receive” mode for receiving data, for example control signals from BAS 100.

According to some exemplary embodiments, power generator 312 may include and/or use a DC/DC converter (e.g., a step-down converter) in combination with sensing or transceiver circuitry operable at lower voltages to initiate one or more of the power modes in wireless device 302 at lower voltages. Reducing the supply of electrical energy needed by circuit 308 or wireless transceiver 316 may reduce overall power consumption.

Wireless device 302 is also shown in FIG. 3A to include or be coupled to a user interface 314 configured to accept an input and provide an output for a user of wireless device 302. For example, for a wireless temperature sensor, an input of a desired room temperature may be accepted (e.g., receiving the input from buttons configured to raise or lower the temperature setting) and a display of the current temperature may be provided by the wireless device. The user interface may include a plurality of buttons, knobs, pushbuttons, other tactile user input methods, display screens (either a touch screen configured to accept an input when touched, or not), other display methods (e.g., an LED), etc. According to an alternative exemplary embodiment, the wireless device may not have a user interface and the task of handling user input and output may be performed by a controller, NAE, or other device which receives information transmitted from the wireless device. Alternatively, the wireless device may not require any user input or the need to provide a user output.

The user interface may also be configured to be used with circuit 308. A user interface including an electronic display may be updated due to an event-driven update or a periodic update, depending on the power available to the wireless device, according to an exemplary embodiment. For example, in an embodiment where circuitry 308 includes a temperature sensor, the current temperature may be displayed. A signal for the display of the wireless device may not be sent (e.g., from processing circuit 318) unless a temperature change (or a significant temperature change) is detected. The display may only update when the signal is received by circuitry for the display, conserving energy when idle. The display can be configured to “hold” a visible output of the display when a signal is not being received by the display circuitry. According to other embodiments, the display is powered down or configured to not provide any display output when a signal is not being received. According to yet other embodiments, a display may only update when a user presses a button on the user interface of the wireless device. A signal may be sent to take a measurement (e.g., a temperature measurement) and to update the display of the wireless device when the button is pressed.

While the illustrated exemplary embodiments describe a wireless device having a communications interface that is a wireless transceiver (e.g., transceiver 316), according to other exemplary embodiments the wireless device includes a communications interface that is a wired interface for coupling to a supervisory controller and/or other BAS devices via a wired connection. The electrical energy received by circuit 308 may be used to transmit over the wired connection (e.g., a bus). The wired connection can be a relatively low-cost and unpowered field bus due to the self-powered nature of devices having circuitry 308.

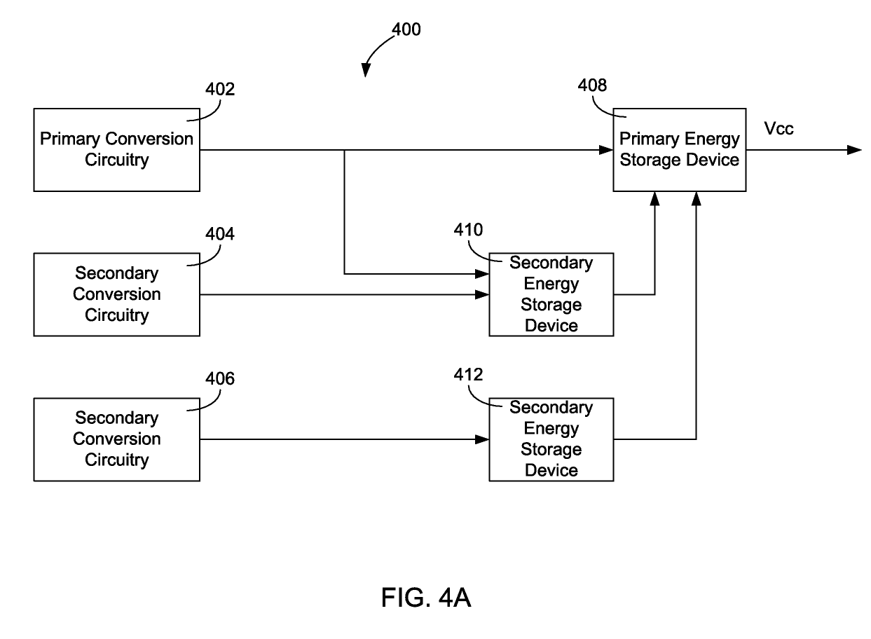

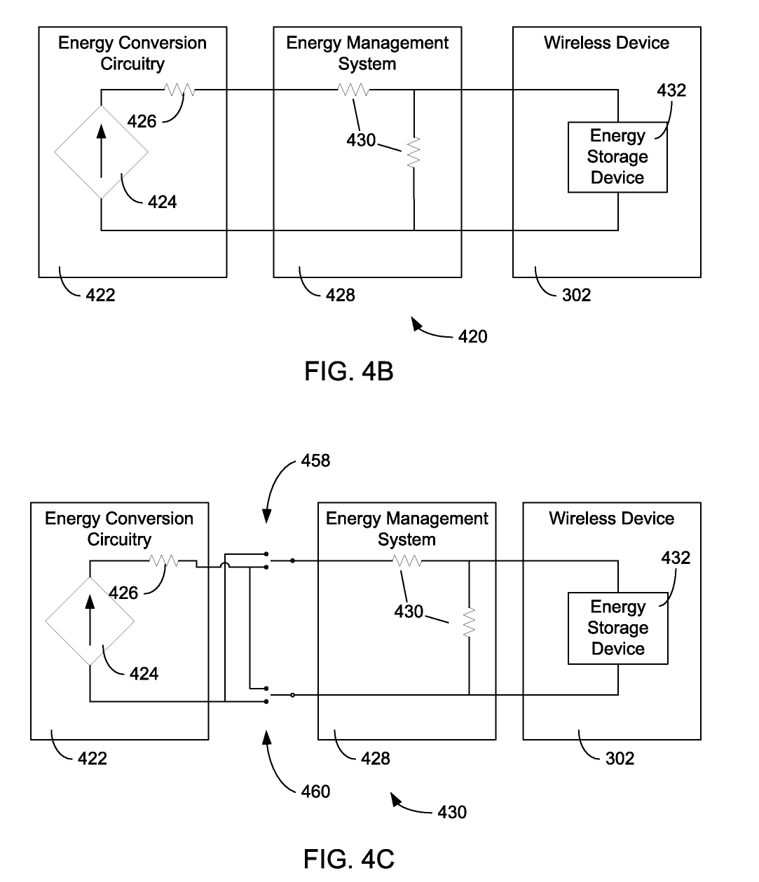

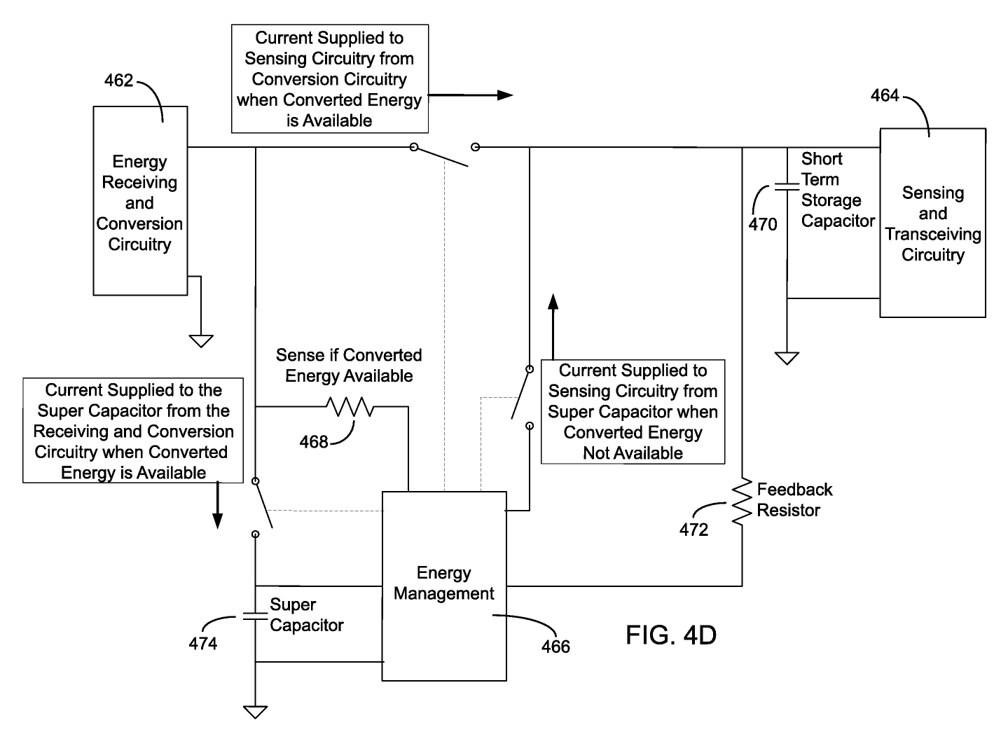

Referring to FIG. 4A, a block diagram of a system 400 for providing a power supply using an multiple energy conversion circuits for a wireless device (e.g., wireless device 302) is shown, according to an exemplary embodiment. Primary conversion circuitry 402 for receiving and converting energy may be used with secondary conversion circuitry 404, 406 for receiving and converting additional energy, for example as a back-up energy supply. Circuitry 402, 404, and 406 may use any conversion technique for converting the non-electrical energy to electrical energy. Conversion circuitry 322 of FIG. 3B may include primary conversion circuitry 402 and secondary conversion circuitry 404, 406. According to various exemplary embodiments, additional primary conversion circuitry and/or secondary conversion circuitry may be implemented or no secondary conversion circuitry may be implemented.

System 400 is also shown to includes various back-up or secondary energy storage devices 410, 412 (e.g., capacitors, batteries, flywheels, etc.) and a main or primary energy storage device 408 for providing a main power supply of electrical energy for the wireless device. Primary energy storage device 408 may be configured to provide a power supply for the wireless device, and may receive power from primary conversion circuitry 402 when primary storage device 408 is not fully charged. In the event primary conversion circuitry 402 is not able to provide an adequate power, main storage device 408 may be provided with energy from one or more of storage devices 410, 412. Storage devices 410 and 412 are configured to store energy for secondary conversion circuitry 404 and 406. According to various exemplary embodiments, additional or fewer storage devices may be used and various types of storage methods may be used. The energy storage devices of FIG. 4A may include the various types of storage methods, including but not limited to capacitors, batteries, flywheels, etc.

According to various exemplary embodiments, when multiple circuits for receiving and converting energy are used, the circuits may receive and convert different or the same type of non-electrical energy. The circuits may also be tuned to receive and convert different ranges of the same type of non-electrical energy. For example, different circuits may receive and convert different frequencies of mechanical vibrations, different temperature ranges or gradients, different magnitudes of light, etc. in order to more optimally receive, sense, and/or convert varying and/or a wide spectrum of non-electrical energy.

Referring to FIG. 4B, a system 420 includes circuitry for providing an electrical power supply using an energy conversion technique for wireless device 302, according to an exemplary embodiment. Energy conversion circuitry 422 includes a source 424 configured to convert received non-mechanical energy into electrical energy and an internal resistance 426. An energy management system 428 includes various loads 430 configured to distribute the electrical energy received from energy conversion circuitry 422 to one or more energy storage devices 432 of wireless device 302. Internal resistance 426 of energy conversion circuitry 422 may be matched by load 430 of energy management system 428 to allow increased power generation for wireless device 302. While the various circuitry is generally shown as resistors, according to various exemplary embodiments, the circuitry may include any number of resistors, capacitors, other electrical components and devices, etc. For example, piezoelectric devices may use bridge rectifiers, voltage clamping circuits, and other circuitry to control the power supply.

Energy management system 428 may include or be coupled to an energy storage device (other than energy storage device 432) and may provide wireless device 302 with the power supply from the energy storage device when energy conversion circuitry 422 is unable to provide the power supply for wireless device 302. According to various exemplary embodiments, energy management system 420 may be embodied in processing circuit 318, in circuitry 422, or be independent circuitry.

Referring to FIG. 4C, a system 440 is similar to system 420 of FIG. 4B, but includes two switches 458, 460. Switches 458, 460 may be used to control the path of the power supply provided by energy conversion circuitry 422. For example, wireless device 302 can be completely disconnected from energy management system 428 to manage itself, can be fully connected to energy management system 428 to receive and send energy, or partially connected to energy management system 428 to only receive or only send energy. The switches may allow routing of the energy to allow for energy conversion when the duct air temperature is warmer or colder than the reference temperature

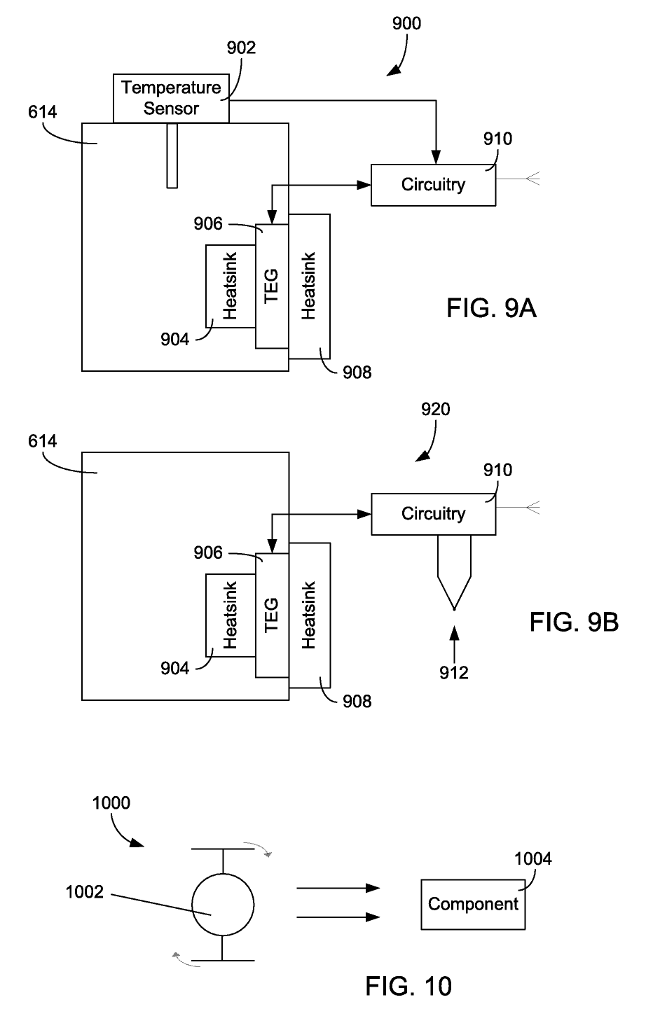

According to one exemplary embodiment, the system of FIG. 4C may be used for a thermoelectric energy conversion system. One portion or a heatsink of a thermoelectric generator (“TEG”) may be coupled to an HVAC duct and another portion or heatsink of the TEG may be outside the duct. When the air in the duct is within a first temperature range (e.g., a temperature cooler than the temperature outside the duct), the current may flow in one direction, but when the air in the duct is within a second temperature range (e.g., a temperature comparatively warmer than the first temperature or warmer than the temperature outside the duct), the current flow may be reversed. For example, the switches may be used to route the TEG current between one electrical path when the air in the duct is cooler than the air outside the duct (e.g., in the summer) and another electrical path when the air in the duct is warmer than the air outside the duct (e.g., in the winter). The two electrical paths may be capable of effectively reversing the polarity of the energy conversion system so that energy can be converted regardless of the air flow or polarity of a temperature gradient. The TEG is shown in greater detail in FIGS. 9A-B.

Referring to FIG. 4D, a more detailed electrical block diagram of a configuration for providing a power supply to the wireless device of FIGS. 3A-D is shown according to an exemplary embodiment. Energy receiving and conversion circuitry 462 (e.g., including receiving circuitry 320 and conversion circuitry 322) is configured to receive non-electrical energy and convert it to electrical energy. Electrical energy or current may be supplied to sensing and transceiving circuitry 464 or 324 from receiving and conversion circuitry 462 when converted energy is available as determined by energy management system 466 via sensing resistor 468. A short term storage capacitor 470 may temporarily store electrical energy to be used by sensing and transceiving circuitry 464 when more energy is available than is being consumed. A feedback resistor 472 may signal the energy management system when current is and is not being supplied to sensing and transceiving circuitry 464. Current may also be supplied to and stored in a super capacitor 474 from the receiving and conversion circuitry 462 when converted energy is available. Current can then be supplied to sensing and transceiving circuitry 464 from super capacitor 474 when converted energy is not available.

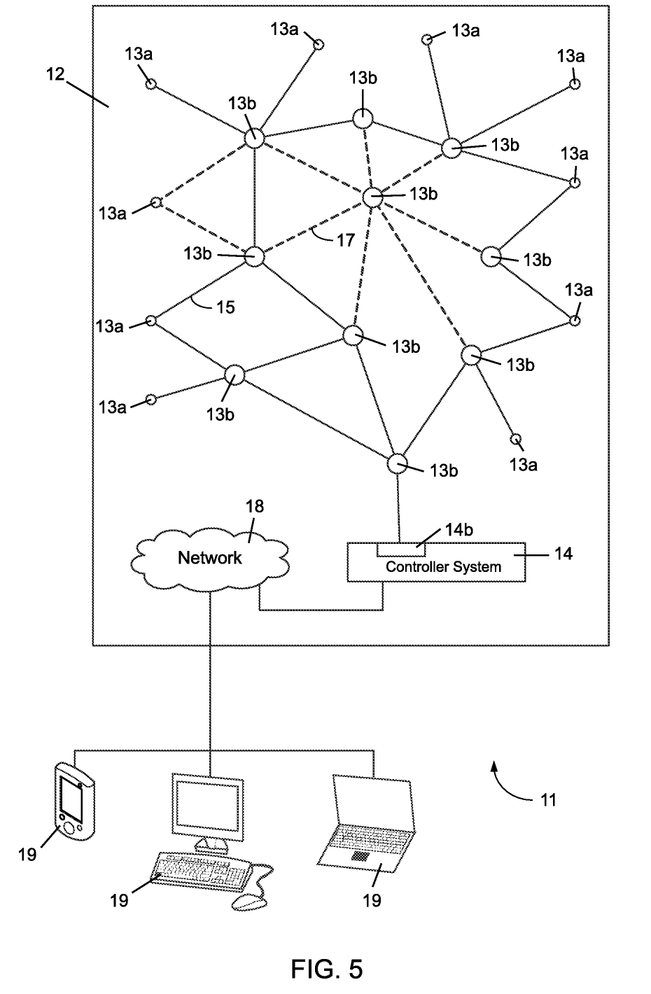

Referring to FIG. 5, a block diagram of wireless devices 13a and 13b wireless devices 13a and 13b may be wireless device 302 shown in FIG. 3A, or include the circuitry of wireless device 302 (e.g., circuit 308)) in a mesh network 11 is shown, according to an exemplary embodiment. A mesh network may be an example of a network formed by the various wireless devices of a building system. According to other exemplary embodiments, the wireless devices may be arranged in other types of network topologies.

In the illustrated embodiment, mesh network 11 includes building area 12, a plurality of wireless devices and sensors 13a, 13b, controller system 14, network 18, and workstations 19 (e.g., a desktop computer, a personal digital assistant (“PDA”), a laptop, etc.). Wireless devices 13a, 13b are interconnected by RF connections 15 (displayed as solid lines). RF connections 17 may be disabled (or otherwise unavailable) for various reasons (displayed as dashed or dotted lines). As a result, some wireless devices 13a, 13b (devices without a connection) may temporarily be disconnected from mesh network 11, but are configured to automatically connect (or reconnect) to any other suitable wireless device 13a, 13b within range. Controller system 14 may be connected to a workstation 19 via network 18, using station 14b to receive input from the various wireless devices 13a, 13b. Mesh network 11 may include a number of wireless devices 13a, 13b that are either full function devices or reduced function devices. For example, the wireless devices might be end devices or reduced function devices 13a that do not have more than one connection on mesh network 11 (i.e., devices 13a do not relay information from other nodes). Alternatively, other wireless devices might be coordinators or routers or full function devices 13b that relay information to and from multiple wireless devices 13a, 13b on mesh network 11.

Using a plurality of low-power and multi-function or reduced function wireless devices distributed around a building and configured in a mesh network, a redundant, agile, and cost-effective communications system for facility systems may be provided. According to an exemplary embodiment, wireless devices 13a, 13b of FIG. 5 are ZigBee compatible devices. ZigBee is the name of a specification related to low cost and low power digital radios. The ZigBee specification describes a collection of high level communication protocols based on the IEEE 802.15.4 standard. A ZigBee compatible device is a device generally conforming to ZigBee specifications and capable of existing or communicating with a ZigBee network. In other exemplary embodiments, wireless devices 13a, 13b could be any kind of radio frequency communicating wireless device including, but not limited to, Bluetooth devices, personal area network (PAN) devices, and traditional 802.11 (Wi-Fi) based devices. According to an exemplary embodiment, wireless devices 13a, 13b may include any type of ZigBee device including ZigBee coordinators, ZigBee routers, ZigBee end devices, etc. As illustrated in FIG. 5, mesh network 11 may include a number of ZigBee devices that are either reduced function devices 13a or full function devices 13b.

Wireless devices 13a, 13b may be end devices, according to an exemplary embodiment. Wireless devices 13a, 13b may be configured to transmit data to controller 14 or other devices of mesh network 11. Wireless devices 13a, 13b may be configured to determine the shortest path or otherwise exemplary path in which to send data on mesh network 11. Various controllers and supervisory controllers of mesh network 11 may function as full function devices 13b of mesh network 11.

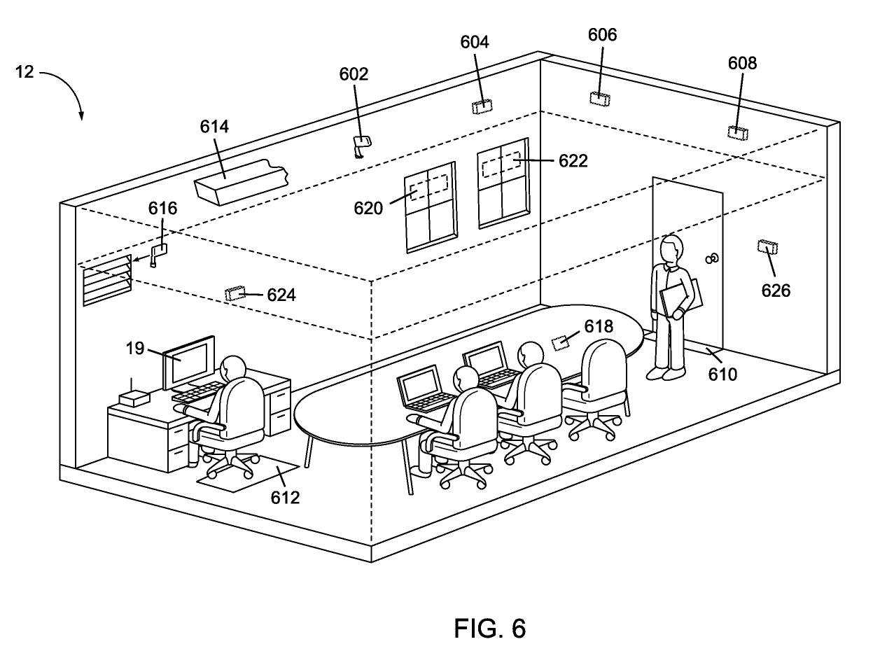

Referring to FIG. 6, a perspective view of a building area 12 having various wireless devices including and/or coupled to a circuit such as circuit 308 is shown, according to an exemplary embodiment. According to other exemplary embodiments, the wireless devices and/or sensors may be placed in any location within building area 12 (e.g., in the floor or ceiling, on walls, on windows, on doors, on tables, on chairs, on any other movable object or secure structure, etc.). The locations of the wireless devices and sensors may vary depending upon user preference and the type of wireless device or sensor. The wireless devices and sensors may be coupled to or otherwise in communication with other devices and sensors.

For example, a plurality of wireless devices 602-608 are shown in the ceiling area (illustrated by the dotted lines in FIG. 6) above building area 12. Wireless devices 602-608 may be detecting such properties as motion, occupancy, temperature, air quality and air properties, etc. Additional wireless devices 610, 612 are shown embedded into the floor of the building area. Such devices 610, 612 may detect motion, occupancy of various users, objects of the building area, or generate power based on pressure being applied to the sensor. Other wireless devices 614, 616 may be within or near an air duct, and may be configured to measure various properties regarding the HVAC system or similar air flow system. Yet another wireless device 618 is shown embedded within a table, and may detect “occupancy” (e.g., if an object such as a computer is on the table at any given time). Still other wireless devices 620, 622 are illustrated on a window panel and may include a solar cell or other energy conversion circuitry configured to convert light energy (e.g., solar light, lights currently lit in the building area, etc.) to electrical energy for a power supply. Other wireless devices 624, 626 are shown on the walls of the building area and may have various functions relating to building area properties. The various wireless devices 602-626 described may include the energy conversion circuitry (e.g., circuit 308) as variously described in this disclosure.

Wireless devices may be placed within a specific range of each other and/or in specific locations, according to an exemplary embodiment. Some wireless devices may transmit at lower frequencies and/or higher frequencies than others in order to provide better transmissions. The wireless devices may be configured to transmit through walls, ceilings, floors, or other sturdy objects.

The wireless devices may allow for a flexible configuration of device locations. The wireless devices may be surface-mounted or coupled to a wall, floor, or ceiling in a variety of ways (e.g., as variously shown in FIG. 6). The wireless devices may be embedded in a wall or table. The wireless devices may include a notch or hole for “fitting” the device into a location. For example, a wireless device may be “propped up” on a wall using an object embedded into the wall. The wireless devices may also be mounted using an adhesive, magnetic tape, screws and nails, or any other object.

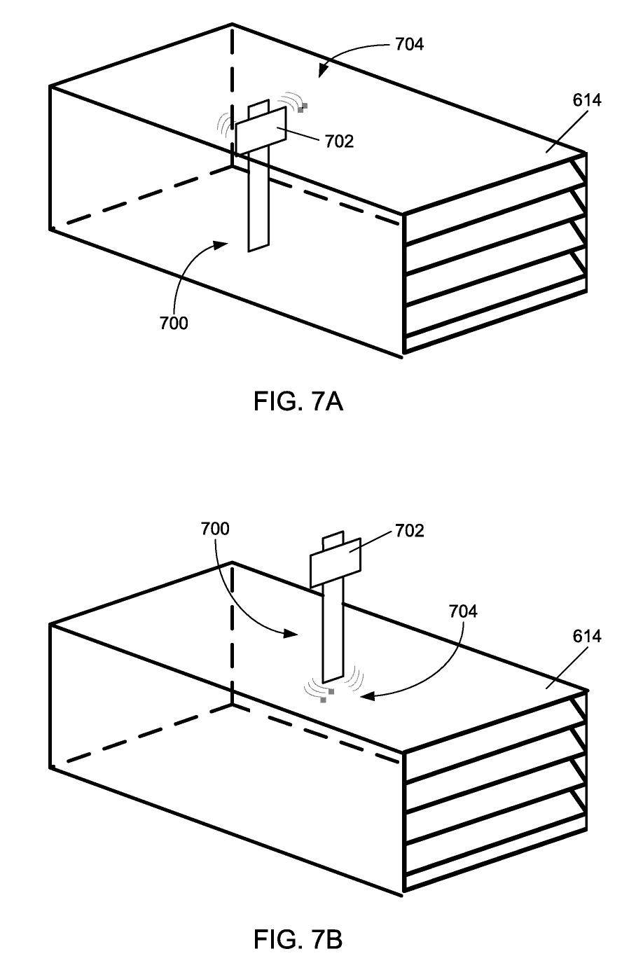

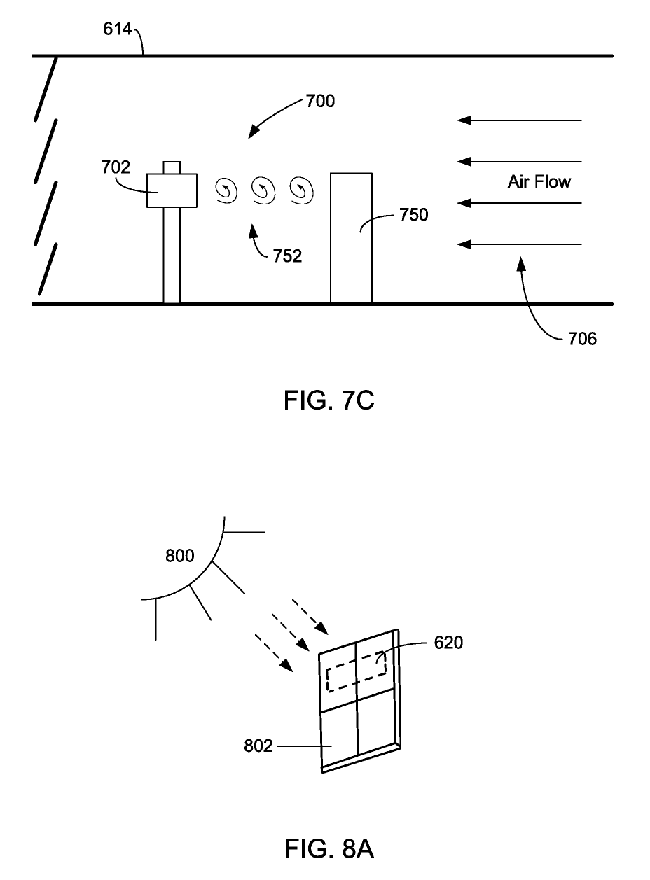

There are a number of energy conversion techniques that may be applied with a wireless device for a building area. FIGS. 7 through 10 illustrate various examples of implementations of wireless devices having energy conversion.

Referring to FIG. 7A, a cutaway view of an air duct 614 of FIG. 6 is shown and includes a wireless device 700 with a piezoelectric sensor 702 according to an exemplary embodiment. Piezoelectric sensor 702 may be installed in the air space within air duct 614, allowing sensor 702 to both measure the vibrations 704 caused by the air flow (e.g., and using the measurements to determine the air flow) and convert vibrations 704 into electrical energy for powering device 700. Air duct 614 may be any AHU, VAV, or other ventilation tunnel or apparatus, according to various exemplary embodiments. Sensor 702 may be located near a fan motor, damper actuator, or other object, increasing efficiency of sensor 702 because of the increased vibration caused by the fan motor, damper actuator, or other object. According to other exemplary embodiments, vibrations 704 may be measured and converted from other building system components (e.g., any component with a motor, vibration from a chiller, etc.). Piezoelectric sensor 702 may be configured to be any shape or size and may be integrated into or on the air duct or other environment in various ways.

Piezoelectric sensor 702 may include circuitry for gathering data about the air flow in air duct 614. Air properties such as air pressure, air flow, etc., may be measured or calculated based on the vibrations and the data may be transmitted to another device or controller. A determination of an “ideal” air flow may be made such that the air flow is adjusted to increase or maximize performance of piezoelectric sensor 702 and associated wireless device 700. For example, the air flow may be increased in air duct 614, providing a larger vibration 704 detected by piezoelectric sensor 702 and resulting in additional energy production by piezoelectric sensor 702. Data regarding air flow can also be fed into a feedback loop of a BAS control loop or BAS control system optimizer (e.g., an extremum seeking control loop).

Referring to FIG. 7B, wireless device 700 and piezoelectric sensor 702 are mounted on the outside of air duct 614, according to an exemplary embodiment. The vibration 704 of air duct 614 may be detected by sensor 702 and the vibrational energy may be converted into electrical energy for a power supply. According to some exemplary embodiments, sensor 702 may detect vibrations 704 of air duct 614 and generate an alarm or other warning if the detected vibrations 704 change in pattern, frequency, or increase beyond or dip below one or more desired values.

Referring to FIG. 7C, a side view of air duct 614 is shown, according to an exemplary embodiment. An air stream or flow 706 may come in contact with an obstacle 750 placed in duct 614 and piezoelectric sensor 702 of device 700. Eddies and air currents 752 may form between piezoelectric sensor 702 and obstacle 750 and the resulting vibration detected by piezoelectric sensor 702 may be converted to electrical energy. The rate of the collisions between eddies 752 and piezoelectric sensor 702 is generally proportional to the air flow 706 in the duct, allowing sensor 702 to measure air flow 706.

According to other exemplary embodiments, the piezoelectric sensor may be used to sense and convert vibrational energy in other applications or environments. For example, chiller vibrations may be used for chiller vibration analysis. The piezoelectric sensor may detect the vibration of the chiller, and the vibrational energy may be converted into electrical energy. Additionally, a sensor may monitor the chiller performance based on the vibrations, and may generate an alarm or other warning when the frequency or amplitude of the vibrations change or when the amount of vibrational energy generated changes.

In general, piezoelectric sensors are configured to generate a power supply from mechanical stress (such as vibrations). The construction of the piezoelectric sensor may be varied in multiple ways (e.g., the number of bimorphs of the sensor, how the sensor is mounted, resonant frequency tuning, etc.) and the sensor may be used in a plurality of settings where mechanical stress may be produced. According to one exemplary embodiment, the bimorph of the sensor may have its wired end clamped, allowing the bimorph to act as a free floating beam. The sensor may be placed in a location where mechanical equipment that resonates at the same frequency as the beam is located, allowing a maximum AC voltage generating capability to exist during oscillation at or near the resonant frequency. The circuitry of the piezoelectric sensor may include circuitry 308 of FIG. 3A and/or may include a rectifier bridge circuit to convert AC output voltage into DC voltage, a voltage regulator to provide a constant power supply for the associated wireless device, and/or energy management circuitry to improve the efficiency of the wireless device. The piezoelectric sensor may include a capacitor, battery, flywheel, or other storage device for energy storage or may allow the wireless device to handle energy storage.

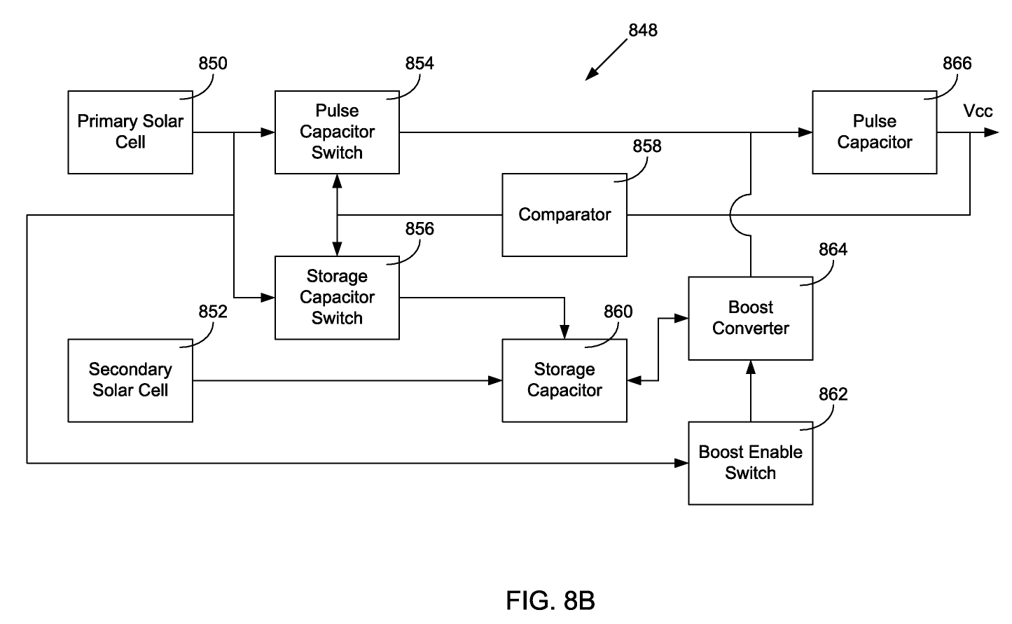

Referring to FIG. 8A, an environment view of a light sensor 620 receiving solar energy from a source 800 is shown, according to an exemplary embodiment. A light source 800 may be the sun, however according to other exemplary embodiments, other light sources (e.g., office lighting) may be used by light sensor 620. Light sensor 620 may be a photovoltaic cell or array or any other ambient light sensor configured to receive solar energy for conversion to electrical energy.

In FIG. 8A, light sensor 620 is illustrated as being on a window 802 of a building area but can be placed anywhere in a building. According to various exemplary embodiments, light sensor 620 may be of any shape, size, or configuration (e.g., a strip that can be placed on a window or wall, an object that may be fastened to a window or wall in a variety of ways, etc.), and may use a plurality of light sources (e.g., sunlight, ambient light, etc.) to generate power. For example, an indoor amorphous photovoltaic cell mounted to a glass surface such as a window may be used as a solar cell for sensor 620.

Referring to FIG. 8B, a system 848 uses a photovoltaic cell (e.g., a solar panel) to provide an electrical energy power supply for a wireless device (e.g., wireless device 302), according to an exemplary embodiment. System 848 may be similar to the systems as described in FIGS. 4A-4C, with the use of solar cells 850, 852 as energy conversion circuitry (e.g., circuit 308). The system may additionally include the use of a comparator 858, boost converter 864, and energy management system components to improve the performance of the wireless device with regards to the power supply provided. The application and use of solar cells 850, 852 and wireless device as illustrated in FIG. 8B may be varied, according to other exemplary embodiments. For example, the wireless device as described in FIG. 8B may be implemented wirelessly in a building area.

Further referring to FIG. 8B, primary solar cell 850 may supply pulse capacitor 866 with power. Pulse capacitor 866 is configured to provide electrical energy for use by the wireless device. Primary solar cell 850 may be configured to provide the main power supply for the sensor and wireless device. However, if pulse capacitor 866 is fully charged, primary solar cell 850 may provide a power supply for storage capacitor 860. Two switches, one switch 854 for pulse capacitor 866 and one switch 856 for storage capacitor 860, may be provided. Switches 854, 856 may be used to direct the power supply provided by primary conversion circuitry 850 to the appropriate capacitor.

Secondary solar cell 852 may be configured to provide power for storage capacitor 860, according to an exemplary embodiment. According to some exemplary embodiments, secondary solar cell 852 may be an optional component of the power supply. According to various exemplary embodiments, multiple primary and secondary solar cells may be included in the energy conversion circuitry.

Pulse capacitor 866 may be configured to maintain a working voltage for an output display when the wireless device indicates a desire for a reading (e.g., after a request from a user), allowing the sensor to make a reading and to provide the resulting data to the wireless device for the output display. Pulse capacitor 866 may also be configured to recharge in a time interval shorter than the designated time interval between scheduled transmissions (for devices which periodically update) to avoid power outages.

Storage capacitor 860 may be configured to store enough charge so that the wireless device may function for an adequate period of time if a power source from the solar cells 850, 852 is not available. For example, storage capacitor 860 may be capable of storing enough charge to power a wireless device for night time when light is not expected and may be fully charged in a set period of time (e.g., capable of being fully charged in an environment with a 50/50 duty cycle in one week, two weeks, etc.). The energy conversion circuitry may include multiple pulse capacitors or storage capacitors, according to various exemplary embodiments.

Comparator 858 may be used to operate switches 854, 856 of the system, allowing primary solar cell 850 to alternate between charging pulse capacitor 866 and storage capacitor 860. According to an exemplary embodiment, comparator 858 has a high trip point and a low trip point that are used to determine the proper capacitor 860 or 866 to which to provide a charge. When a high trip point is detected from pulse capacitor 866, pulse capacitor switch 854 may be opened and storage capacitor switch 856 may be closed, allowing primary solar cell 850 to charge storage capacitor 860. Likewise, when a low trip point is detected from pulse capacitor 866 when its output power is low, pulse capacitor switch 854 may be closed and storage capacitor switch 856 may be opened, allowing the primary conversion circuitry (e.g., primary solar cell 850) to charge the pulse capacitor 866. Switching between pulse capacitor 866 and storage capacitor 860 may be done to quickly charge pulse capacitor 866 for use. Quickly charging pulse capacitor 866 may allow the sensor to power up and start sensing and transmitting data in a relatively short time (e.g., a few minutes).

In the case where pulse capacitor 866 requires energy and the solar cell is unable to provide sufficient energy, a boost converter 864 may be used. Boost converter 864 may charge pulse capacitor 866 using a power supply from storage capacitor 860. Boost converter 864 may be configured to manage the energy storage capabilities of the wireless device and to regulate the output voltage provided to pulse capacitor 866. Boost converter 864 may be designed to maximize the use of storage capacitor 860, allowing the capacitor size to be minimized. The amount of useful energy may be increased by drawing from a range of the storage capacitor voltage levels. By setting the voltage output of storage capacitor 860 higher than the working voltage of the pulse capacitor, pulse capacitor 866 charge times may be reduced. A boost enable switch 862 may be included to improve efficiency. For example, if the comparator 858 output is high or if primary solar cell 850 is providing sufficient power, switch 862 may be turned off. Otherwise, if the power supply from storage capacitor 860 is needed, switch 862 may be turned on. The system may be configured to prevent capacitor leakage to the extent possible.

Primary solar cell 850 and secondary solar cell 852 of the system may be replaced with various other energy conversion circuitry and the setup of system 848 may be adapted for any other energy gathering and/or conversion technique, according to other exemplary embodiments. According to other exemplary embodiments, the capacitors of FIG. 8B may be any combination of capacitors, batteries, flywheels, and/or other energy storage devices.

The building area of FIG. 6 may include thermoelectric sensors and thermoelectric generators. Thermoelectric generators may operate based on the principle of the Seebeck effect in which multiple thermocouple junctions connected in series generate a voltage output when a temperature differential exists across the series. The thermoelectric sensor may be placed on any relatively warm object within the building area and the temperature difference between the two sides of the sensor may be used by the thermoelectric generator of the thermoelectric sensor to provide a voltage output and/or to provide various temperature sensing and/or estimating activities.

One application of a thermoelectric sensor may be for an air duct. The thermoelectric sensor may be used to detect the temperature of air inside the air duct, and a power supply for the sensor may be provided by energy conversion techniques (e.g., generating a power source from the local temperature difference between air inside and outside of the air duct). For example, one side of the sensor may be placed inside of an air duct having a temperature of 65 degrees Fahrenheit, and the other side may be located on the outside of the duct area where the temperature is 90 degrees Fahrenheit. The magnitude of the voltage generated by the TEG of the thermoelectric sensor may be proportional to the magnitude of the temperature difference between air outside of the duct and air inside the duct.

Referring now to FIG. 9A, a thermoelectric sensor 900 may include a temperature sensor 902, TEG 906, and circuitry 910. Two heat sinks 904, 908 are coupled to TEG 906; a first heat sink 904 is inside air duct 614 and another heat sink 908 is outside of air duct 614. Heat sinks 904, 908 may provide a way to provide a more representative indication of the temperature difference between the outside air and air inside air duct 614. The temperature difference may be used to generate a voltage to power the wireless device and/or to enable wireless transmission and/or receptions by the wireless device.

Referring still to FIG. 9A, temperature sensor 902 detects (e.g., senses, estimates, calculates, etc.) the duct air temperature and is coupled to circuitry 910 for transmitting the sensed temperature data. TEG 906 may also be a part of and/or electrically coupled to circuitry 910 (e.g., a circuit board and/or other processing components) to provide electrical energy. Circuitry 910 may include circuitry for wirelessly communicating data (e.g., temperature data) with a building automation system. Circuitry 910 is also configured to provide the voltage from TEG 906 as electrical energy for the rest of the wireless device. Circuitry 910 may include components for conversion between analog and digital signals. Further, circuitry 910 may calculate air temperature outside the duct based on the detected temperature inside the duct.

Referring to FIG. 9B, thermoelectric sensor 920 includes TEG 906, processing components and circuitry 910, and a thermistor 912 coupled to circuitry 910. Thermistor 912 may be configured to determine the temperature of the air outside of air duct 614. Using the temperature reading of thermistor 912 and the voltage from TEG 906, the air temperature inside of duct 614 may be determined without the use of separate temperature sensor 902 (as illustrated in FIG. 9A). The relationship between the voltage generated by TEG 906 and the outside air (e.g., ambient air) temperature is generally proportional (e.g., linearly proportional). The voltage is proportional to the difference between the outside air temperature and inside air temperature, while the initially unknown inside air temperature is proportional to the voltage and the outside air temperature. Therefore, the inside air temperature may be calculated and provided to a control system. Circuitry 910 may include components for completing the conversion activities and for calculating the values used in the temperature determinations.

The use of the components of thermoelectric sensor 920 of FIG. 9B allow a temperature reading to be obtained for a building area, and may allow a building automation system controller to manage other devices systems based on temperature settings relative to the temperature readings. According to an exemplary embodiments, thermoelectric sensor 920 may use the electrical energy generated by TEG 906 to power itself.

Referring to FIG. 10, a schematic illustration of a brushless motor 1000 (e.g., a brushless DC motor) is shown, according to an exemplary embodiment. Brushless motor 1000 may be used in a building area in a variety of ways. For example, motor 1000 may be installed in a duct. A propeller attached to rotor 1002 of motor 1000 and the air flow received by the spinning propeller may be used to spin the motor. Motor 1000 may convert the air flow energy from three-phase AC voltage to DC voltage (e.g., using a rectifier). The mass of rotor 1002 may reduce the need for hardware filtering as it may limit the frequency of the energy being input. A device associated with brushless motor 1000 may be configured so that the frequency of the AC voltage produced by motor 1000 is proportional to the air flow in the area (e.g., in a duct), allowing air flow to be measured by a wireless device associated with brushless motor 1000.

Motor 1000 may receive an air flow supply for various components 1004 of a building area. One example of an implementation of a brushless motor in energy conversion circuitry may be for a VAV box. The use of a brushless motor may eliminate the need for a flow tube, differential pressure (“DP”) sensor, and a power source (e.g., 24V power source) to the VAV box. The brushless motor may be used to generate electrical energy using an air flow in the duct. Sufficient electrical energy may be generated/converted to operate the VAV box and a communications interface (e.g., wireless transceiver 316).

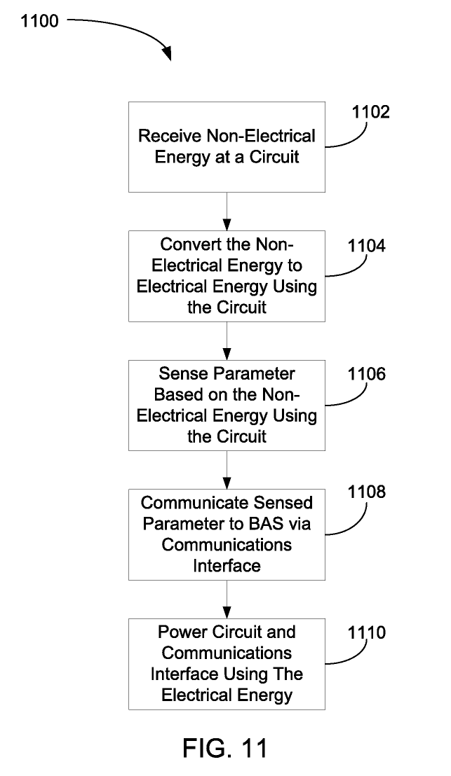

Referring to FIG. 11, a method 1100 for converting energy in a BAS (e.g., BAS 100) is shown. A circuit (e.g., circuit 308) receives non-electrical energy (e.g., mechanical, thermal, light, etc.) from an environment (e.g., a building zone, an air duct, etc.) in which the circuit is placed (step 1102). The circuit then converts the received non-electrical energy into electrical energy (e.g., using a piezoelectric, pyroelectric, electrostatic, thermoelectric, radiation collecting, photovoltaic device, etc.) (step 1104). The circuit senses a parameter (e.g., an air flow, a temperature, a light intensity, etc.) based on the non-electrical energy (step 1106). A communications interface receives the sensed parameter and communicates the sensed parameter (via a wireless or wired connection) to the BAS (step 1108). The electrical energy is used to power the circuit and/or the communication interface (step 1110). It is noted that while method 1100 is shown to have specific steps, according to other exemplary embodiments, the steps can be in any order or one or more of the steps can be performed in parallel. For example, non-electrical energy may be substantially continuously received and converted by the circuit providing power to sense parameters and communicate the parameters to the BAS.

Referring back to FIG. 6, various other sensors may be used in a building area as energy conversion circuitry associated with a wireless device. Flow sensors may be used to measure the rate of flow (e.g., fluid flow, air flow, etc.) and can be configured to aid in converting non-electrical energy (e.g., mechanical energy) created by the flow into electrical energy. For example, a flow sensor may be used to both detect the flow of air in a duct and harvest energy from the flow. A sensor may calculate the rate of air flow in the duct based upon the voltage produced. Alternatively, the sensor may directly measure the air flow.

As another example, water flow may be detected and used as part of a circuit for receiving and converting energy. A flow sensor may generate electrical energy from the water flow and may measure the rate of water flow based upon the voltage produced. Alternatively, the sensor may directly measure the water flow.

Pressure sensors may be used in a similar manner to motion sensors. For example, a pressure sensor may be placed at a doorway and may detect the pressure from an occupant's body weight when the person steps on the sensor, allowing the pressure sensor to detect occupancy in a building area. Occupancy signals can be used by an HVAC system to, for example, increase the amount of ventilation provided to a building area. The pressure created by the occupant may be used by energy conversion circuitry to generate a power supply. In addition, the opening of a door of a building area may generate movement and/or vibrations that may be converted into a power supply to power the devices of a room (e.g., a controller for lights) when the door is opened. Actuation of the pressure sensor may be used to count or track people to provide a feed-forward signal for a BAS controller used in an HVAC system for a building zone, for security considerations, and/or for triggering greater ventilation for more people or less ventilation for fewer people.

A sensor may be placed on or embedded within a table with a laptop computer or other movable object, and may have a spring or heat sensor. The spring may be able to detect when a laptop computer is lifted and then moved, and the resulting spring movement may be converted into a power supply for various controllers. For example, if the spring is embedded into the table, a wireless device coupled to the spring may receive a power supply. Likewise, a heat sensor may produce a power supply based on the heat emitted by the laptop computer or other object.

Other implementations of energy conversion circuitry may include other heat source sensors, magnetic field sensors, humidity sensors, etc. Any of the potential circuits may be located in a variety of places (e.g., the sensor may be a zone sensor, duct-mounted sensor, a sensor mounted to a wall, etc.).

The various sensors as described may not use a battery, allowing a user of the building area more freedom to install and implement the sensors and associated devices in locations that may not be easily accessible.

Further, the controller that receives a parameter of the environment (or the wireless device itself) may use the parameter to improve performance of the wireless device with regards to providing its own power supply. For example, a controller may detect that a piezoelectric sensor is most efficient when the air flow is at a certain level, and may adjust the air flow to improve the performance of the piezoelectric sensor. Yet further, a parameter (e.g., resistance, impedance, etc.) of a sensing element or circuitry of the wireless device may be changed based on one or more efficiency determinations.

The present application contemplates methods, systems and program products on any machine-readable media for accomplishing its operations. The embodiments of the present application may be implemented using existing computer processors, or by a special purpose computer processor for an appropriate system, incorporated for this or another purpose.

It is important to note that the construction and arrangement of the energy conversion applications as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments without departing from the scope of the present application.

Embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program codes in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

What is claimed is:

1. A device for use in a building automation system, comprising:
a first circuit configured to receive non-electrical energy from an environment in which the device is placed and to convert the non-electrical energy to electrical energy, the electrical energy being used to power the first circuit, wherein the first circuit is configured to sense a parameter of the environment based on the non-electrical energy; and
a communications interface configured to be powered by the electrical energy and configured to communicate the sensed parameter to the building automation system.

2. The device of claim 1, wherein the communications interface comprises a wireless transceiver.

3. The device of claim 1, wherein the first circuit comprises at least one of a piezoelectric element and an electrostatic element for the sensing and converting.

4. The device of claim 1, wherein the first circuit comprises at least one of a thermoelectric element, a pyroelectric element, an element for collecting ambient radiation, and a photovoltaic element for the sensing and converting.

5. The device of claim 1, wherein the building automation system comprises a heating, ventilation, and air-conditioning (HVAC) system.

6. The device of claim 5, wherein the parameter is an air flow or a temperature of the environment.

7. The device of claim 1, further comprising:
an energy storage device,
wherein the first circuit is configured to provide electrical energy to the energy storage device.

8. The device of claim 7, wherein the electrical energy is used to power the first circuit by receiving stored electrical energy from the energy storage device.

9. The device of claim 1, further comprising:
a secondary power source configured to provide electrical energy when the first circuit is not converting the non-electrical energy into electrical energy at a rate sufficient to power the first circuit.

10. The device of claim 1, wherein the first circuit is configured to route the electrical energy based on the parameter of the non-electrical energy; and
wherein the routing comprises switching between two or more electrical paths, a first electrical path configured to respond in a first way to electrical energy and a second electrical path configured to respond in a second way to the electrical energy.

11. The device of claim 1, further comprising:
a second circuit configured to receive second non-electrical energy from the environment and to convert the second non-electrical energy to electrical energy, the electrical energy being used to power the second circuit, the second circuit configured to sense a second parameter based on the second non-electrical energy.

12. The device of claim 11, wherein the second non-electrical energy received by the second circuit is of a different type of non-electrical energy than that received by the first circuit.

13. The device of claim 11, wherein the second circuit is tuned for a different parameter range of the non-electrical energy as compared to the parameter range used by the first circuit.

14. The device of claim 1, wherein the first circuit is configured to use time constant information for a process, the time constant information received at the communications interface to adjust the rate at which the first circuit senses a parameter of the environment based on the non-electrical energy, wherein sensing the parameter and communicating the parameter to the building automation system form a step of the process; and
wherein the first circuit is further configured to adjust a communications parameter of the communications interface based on at least one of the sensed parameter, a measure relating to the electrical energy, and state of charge information of an energy storage device coupled to the first circuit and configured to receive the electrical energy.

15. A method for converting energy in a building automation system, comprising:
receiving non-electrical energy at a first circuit from an environment in which the first circuit is placed;
converting the non-electrical energy to electrical energy using the first circuit;
sensing a parameter based on the non-electrical energy using the first circuit;
communicating the sensed parameter to the building automation system using a communications interface; and
powering the first circuit and the communications interface using the electrical energy.
